(19) United States
(12) Patent Application Publication
(10) Pub. No.: US 2006/0191075 A1
(43) Pub. Date: Aug. 31, 2006

(54) Methods and compositions for cleaning articles

(75) Inventors: Steven Stoessel, Niskayuna, NY (US); Thomas Fyvie, Schenectady, NY (US); Darren Hallman, Clifton Park, NY (US); Teresa Rocha, Waterford, NY (US); Renu Aggarwal, Schenectady, NY (US)

Correspondence Address: Charles W. Calkins;Kilpatrick Stockton LLP, 1001 W. Fourth Street, Winston-Salem, NC, 27101, US

(73) Assignee: General Electric Company

(21) Appl. No.: 11/291,196

(22) Filed: Dec. 1, 2005

Related U.S. Application Data
(63) Continuation of application No. 10/354,801, filed on Jan. 30, 2003, now abandoned.

(51) Int. Cl. C11D 3/00

(52) U.S. Cl. 8/115.51

(57) ABSTRACT

The present invention provides methods and compositions for cleaning using dual phase wash solutions. The dual phase wash solutions comprise emulsions of polar and non-polar solvents with emulsifiers, surfactants and detergents. The methods of the present invention comprise the steps of charging an article to a washing machine comprising a washing drum, exposing the article in the wash drum to a wash solution comprising 0.125 to 20 percent water; a detergent comprising an ionic surfactant, a non-ionic surfactant and an emulsifier; and decamethylcyclopentasiloxane, agitating the article and wash solution in the washing drum, draining the wash solution from the drum, optionally, adding a rinse solution comprising substantially the same components as the wash solution; agitating the article in the rinse solution; and separating the rinse solution from the article by allowing the rinse solution to drain out of the drum and spinning the drum to drive off residual rinse solution through centrifugal force.

This application is a continuation application of and claims benefit under 35 USC 120 to U.S. application Ser. No. 10/354,801 filed on Jan. 30, 2003, the entire contents of which are hereby incorporated by reference.

### FIELD OF THE INVENTION

This invention relates to the field of cleaning articles: clothing, textiles and the like, in a dual phase solution comprising an emulsion of polar and non-polar solvents. More particularly the present invention is drawn to compositions and methods for cleaning articles with various amounts of polar solvent emulsified in a non-polar medium.

### BACKGROUND OF THE INVENTION

In traditional water-based laundering, detergents are employed to remove insoluble stains and particulates. The insoluble stains in water-based laundering are often lipophilic and do not dissolve in water. The detergents used in laundering employ surfactants, which are molecules containing both hydrophilic and lipophilic groups. Their dual nature allows them to dissolve in water through the hydrophilic group while the lipophilic groups surround the oil-based stain and remove it from the article. The lipophilic stains are surrounded by the lipophilic groups of the surfactant, kept suspended in the water, and carried away from the article in the wastewater stream. While this is a highly effective method of removing stains from articles that are amenable to water-based washing, there are articles that are damaged by excess water, thus this process cannot be used.

Dry cleaning is the cleaning of articles using limited amounts of water in the process. Dry cleaning solvents work by dissolving stains left on clothes. As would be expected, oil-based stains, such as those left by body oils, fats and greases, cosmetics, and other highly aliphatic materials that mar the appearance and performance of clothing, are readily removed. Water-based stains, typical of those left by food and beverages and fluid materials after the water of solvation has evaporated, need to be removed by other methods. This is traditionally conducted in the dry cleaning profession by spot cleaning. Spot cleaning is a laborious process involving a close visual inspection of each garment, followed by the marking and treatment of stains with an appropriate cleaning method. To conduct the process in an acceptable manner not only requires considerable time and extra cleaning equipment, but also extensive experience to recognize and employ the correct cleaning techniques.

A related problem is that most surfactants, particularly charged (ionic) surfactants, are completely insoluble in non-polar cleaning solutions. Thus it is difficult to introduce them into the cleaning medium. Non-ionic surfactants are more soluble in non-polar cleaning solutions; however, they are less effective in cleaning hydrophilic stains.

Another problem arises due to the slight polarity of many fabric materials. If a polar stain is removed from the article, it is likely to redeposit back onto the article before the end of the wash cycle. This occurs because the polar stain is more attracted to a high-energy surface such as the article, than a low energy medium such as the non-polar cleaning solution. This problem is discussed in more detail in “Surfactants and Interfacial Phenomena” 2^{nd} Ed., John Wiley & Sons, New York: 1989.

Commercial dry cleaning is traditionally done by spot cleaning the hydrophilic stains followed by a wash in a machine using an organic solvent to remove general body oils. Perchloroethylene (PERC) is the most common solvent used, but PERC is recognized as a hazardous solvent, unsafe for home use, and is under tremendous regulatory pressure by governments worldwide to be phased out of use. (Fabricare, International Fabric Care Institute, May 2002.) It is specifically prohibited for use as a dry cleaning fluid to the general public to some locales, for example in New York City.

Several alternate solvents for dry cleaning have been explored including Stoddard solvent (hydrocarbon), fluorinated ethers (see, Baran Jr. et al., U.S. Pat. No. 6,159,917), super-critical carbon dioxide (see, Jureller et al., U.S. Pat. No. 5,683,473), and low molecular weight siloxane fluids. (see, Berndt, U.S. Pat. No. 6,042,617) All of these fluids, except siloxane fluids, require specialized chemical process equipment. Only siloxane fluids are benign enough to extend dry cleaning potential to individual consumers; i.e. household use.

A recent patent application describing a washing machine suitable for domestic use that utilizes siloxane compositions for laundry has been filed entitled “Apparatus and Method for Article Cleaning”, U.S. patent application Ser. No. 10/127,001 filed Apr. 22, 2002 and commonly assigned herewith, and is herein incorporated in its entirety by reference.

To broadly summarize, these disclosures describe a machine with the footprint of a typical home water washing machine, and it consists of a basket within a tub, dryer system, and solvent recovery cartridge. Clothes and fabric to be washed are placed in the basket and then the items are immersed in a siloxane-based cleaning fluid. Tumbling gently agitates the load. The spent fluid is removed by spinning the basket. If desired, a rinse step can be conducted by using fresh fluid; otherwise any residual fluid in the clothes is evaporated with warm air. The fluids are recovered and rectified by filtration via a solvent recovery cartridge.

A frustrating issue faced by the dry cleaning industry is the non-uniformity of dirt and stains which occur on articles, particularly clothing. Stains can be separated into two general categories: lipophilic or oil-based compounds such as those left by body oils, fats and greases, cosmetics, and other highly aliphatic materials; and hydrophilic or water-soluble compounds such as fruit juice, ink and wine. A hydrophilic solvent will not dissolve oil-based stains and, conversely, a lipophilic solvent will not dissolve water-based stains.

An earlier filed patent application, “Compositions and Methods for Cleaning” U.S. patent application Ser. No. 10/171,312, filed Jun. 13, 2002 and commonly assigned, is herein incorporated by reference in full and describes suitable cleaning compositions utilizing dual-phase cleaning for removing stains in siloxane fluids. One of the advantages of using siloxane as a wash fluid is improved clothes care. Clothes come out softer, less wrinkled, with less wear, and shrinkage than with water washing. Water washing in combination with heated drying can cause excessive shrinkage, particularly in delicate fabrics or traditionally dry-cleaned garments. Incorporation of small amounts of polar solvents emulsified into siloxane oils improves the removal of water-based soils and maintains the advantages of siloxane cleaning.

“Little doubt exists that laundry wastewater must be generally regarded as a heavily contaminated medium; it cannot be returned to receiving waters in untreated form. As a result of dilution [normally exceeds a factor of 10] in the public sewage system and in sewage treatment plants . . . is biological treatment of laundry wastewater in a normal sewage treatment plant even feasible. Otherwise, major problems would be raised in dealing with the load of organic pollutants introduced by household and commercial laundry operations.” (G. Jakobi and A. Löhr Detergents and Textile Washing, VCH, Weinheim, Germany: 1987, p. 167 ff.) Thus, it would be desirable to have a wash process that contributes little or no wastewater.

Although it would be desirable to have a universal dry-cleaning cleaning fluid which is effective on both oil-based stains and water-based stains, and would not damage water-sensitive articles, the enormous variety of fabrics, styles, weaves, and garment construction available in today's marketplace, combined with the infinite number and degree of stains in the world makes this almost impossible to achieve. However, a cleaning fluid that could be adjusted in the washing machine to suit a particular load, fabric, degree and type of stain would be more practical.

### SUMMARY OF THE INVENTION

The present invention describes wash conditions, cleaning compositions, selection criteria and machine attributes required to safely wash clothes of all types and degrees of staining in a washer utilizing dual-phase, preferably siloxane-water emulsions as the cleaning fluid.

One aspect of the present invention provides a cleaning composition, or wash fluid comprising a non-polar solvent, 0.125 to 20 weight percent of a polar solvent, up to 0.5 weight percent of an ionic surfactant, up to 0.5 weight percent of a non-ionic emulsifier, and up to 0.5 weight percent of a non-ionic surfactant.

One embodiment of the present invention provides a method for cleaning an article comprising the steps of first charging an article to a washing machine comprising a washing drum, then exposing the article to a dual phase wash solution comprising a polar solvent and a non-polar solvent, wherein the polar solvent is emulsified in the non-polar solvent, then agitating the article in the wash solution, and finally separating the wash solution from the article.

In another embodiment of the present invention, a method for cleaning an article is provided comprising the steps of first charging an article to a washing machine comprising a washing drum, then exposing the article in the wash drum to a wash solution comprising 0.125 to 20 percent water; a detergent comprising an ionic surfactant, a non-ionic surfactant and an emulsifier; and decamethylcyclopentasiloxane, agitating the article and wash solution in the washing drum, draining the wash solution from the drum, adding a rinse solution comprising substantially the same components as the wash solution; agitating the article in the rinse solution, and separating the rinse solution from the article by allowing the rinse solution to drain out of the drum and spinning the drum to drive off residual rinse solution through centrifugal force.

Embodiments of the present invention also provide a wash fluid comprising 10 to 20 weight percent of a polar solvent, 0.01 to 0.5 weight percent of an ionic surfactant, 0.01 to 0.5 weight percent of a non-ionic emulsifier, 0.01 to 0.5 weight percent of a non-ionic surfactant.

A feature and advantage of the present invention is that by minimizing the use of water and polar solvents, the energy required to dry the clothes after washing is greatly reduced. The non-polar nature of siloxane fluid makes it easier to remove from clothes after cleaning since it is not tightly bound to the fabric, as is water. This greatly reduces the energy required for drying.

The present invention has the advantage of performing all the cleaning in a single wash-rinse cycle. The benefits of cleaning with each phase (polar and non-polar) separately are combined by the use of the emulsion. It is neither necessary nor desirable to change the predominate phase of the wash liquor, nor is a “fabric refreshment step” required as taught by Noyes, et al. U.S. patent application Ser. No. 09/849,842 (to Procter & Gamble). Furthermore, the extensive use of siloxane provides benefits to the consumer for ease of use, safety, low energy consumption, and conservation of water.

Another feature and advantage of the present invention is that the process conserves water. A full load of clothes washed with a dual-phase wash solution uses roughly 98 percent less water and 50-75 percent less detergent than clothes washed with a conventional vertical axis home washing machine (with wash and one rinse) and yet the same degree of cleaning can be achieved. The impact on environmental conservation is far-reaching. In addition to outright savings of the treated water supply, further reduction of wastewater and pollutant loading is occurring.

A further feature and advantage of the present invention is that recovery of the non-polar fluid helps minimize the environmental impact and reduce operating costs. It also increases the overall generally utility of the machine and the convenience in which it can operated.

### BRIEF DESCRIPTION OF THE DRAWINGS

FIG. 1. is a flow chart showing a process of an embodiment of the present invention.

FIG. 2. is a flow chart showing a process of an embodiment of the present invention.

FIG. 3. is a flow chart showing a process of an embodiment of the present invention.

### DETAILED DESCRIPTION

The present invention includes compositions and processes for cleaning articles at home or in a professional laundry. The compositions of the invention generally comprise at least one non-polar solvent and at least one polar solvent. One solvent being emulsified in the other, these compositions are known as dual-phase cleaning solutions as the polar phase and non-polar phase are immiscible. Further additives include at least one ionic surfactant and at least one emulsifier. Other additives may also be employed in the practice of this invention as will be discussed later.

As used herein, the term “articles” is defined, for illustrative purposes and without limitation, as fabrics, textiles, garments, linens and any combination thereof.

As used herein, the terms “emulsion” and “cleaning solution” are used interchangeably. Both refer to a composition comprising at least one non-polar solvent and at least one polar solvent. The polar solvent is dispersed throughout the non-polar solvent, or vice versa, to form a microscopically heterogeneous stable dispersion.

As used herein, the term “stain” as it relates to cleaning solutions and methods refers to any undesirable foreign substance on the article to be cleaned. It may be organic or inorganic, clear or colored, hydrophilic or lipophilic, liquid or solid, and is not meant to be limited to any particular class of compounds.

In one aspect of the present invention, wash solutions are presented which are better suited to clean both hydrophilic and lipophilic stains. Various embodiments of the wash solution are employed in the processes and methods of cleaning described herein. The relative amounts of the constituent parts of the wash solution will vary depending on the cleaning requirements of the wash solution and the type of article being cleaned. Generally, the wash solutions employed in the present invention comprise a polar solvent, a non-polar solvent, and optionally an emulsifier, an ionic surfactant and various additives.

The non-polar solvent functions to break up lipophilic stains on articles and carry the stains away from the article in the wash solution. The non-polar solvent is also the carrying medium for the other constituents of the cleaning solution. Suitable non-polar solvents for use in the invention include those that, while effectively eliminating lipophilic stains from the article, will not discolor or fade the articles by attacking the coloring agents used therein. In one embodiment of the invention the non-polar solvents comprise siloxanes, such as cyclic siloxanes. In a preferred embodiment of the invention the non-polar solvent comprises decamethylcyclopentasiloxane. Small percentages of higher cyclic homologues such as dodecylmethylcyclohexasiloxane, tetradecylmethylcycloheptasiloxane, and hexadecylmethylcyclooctasiloxane, may exist in the decamethylcyclopentasiloxane. In further embodiments of the invention non-polar solvents include supercritical carbon dioxide or fluorinated refrigerants such as chlorinated fluorocarbons. In still further embodiments of the invention, other petroleum distillates such as Stoddard petroleum distillate or mineral spirits or synthetic hydrocarbons such as Exxon's DF-2000™ may be employed. Some of these commercial non-polar solvents may also include various additives.

Polar Solvent

Non-polar fluids are effective at removing lipophilic stains from articles. However, they are not effective at removing hydrophilic stains. Therefore, a polar solvent may be added to the cleaning solution to aid in the removal of such hydrophilic stains. The polar solvent employed in the invention functions to dissolve the water-based stains from the article to be cleaned. Additionally, the polar solvent carries hydrophilic additives which may be desirable in the cleaning solution. Polar solvents suitable for use in the invention include those that will break up and dissolve hydrophilic stains and can be emulsified in the non-polar solvent of the invention. Therefore, the polar solvent must be immiscible in the non-polar solvent so that they may be emulsified. In a preferred embodiment of the invention, the polar solvent comprises water. Water provides a good polar solvent and also readily solubilizes the ionic surfactants and additives used in some embodiments of the invention. In still further embodiments of the invention glycols, phenols, nitrites, aprotic solvents, ketones, aldehydes, simple alkyl alcohols and glycerin are examples of other suitable polar solvents.

In embodiments of the present invention the amount of polar solvent will vary depending on the nature of articles to be washed and the stains thereon, but generally comprises a sufficient amount to provide an acceptable level of cleaning without undue shrinkage of the article.

Emulsifier

In an embodiment of the present invention, an emulsifying agent may be employed in order to achieve an emulsion. Surfactants make good emulsifiers for the purposes of this invention. In another embodiment of the invention non-ionic surfactants are employed as emulsifiers for the cleaning solution. They are more soluble in the non-polar liquid which comprises the major portion of the cleaning solution. Suggested emulsifiers include, but are not limited to; poly(ethylene glycol)s, poly(propylene glycol)s, sorbitan sesquioleate, sorbitan oleate, sorbitan isostearate, sorbitan trioleate, sodium bis(2-ethylhexyl)sulfosuccinate, polyglyceryl-3 oleate, fatty acid esters, and alkylalkoxy alcohols. In yet another embodiment of the invention, emulsifiers comprise sodium dodecylbenzene sulfate or sodium lauryl sulfate.

In further embodiments of the invention emulsifiers include siloxane based emulsifiers. Examples of these include ethoxylated and propoxylated siloxanes such as a dimethylsiloxane (60% propylene oxide, 40% ethylene oxide) block copolymer or siloxanes and silicones, dimethyl, 3-hydroxypropyl methyl, ethers with polyethylene-polypropylene glycol mono-butyl ether. Examples of these are sold under the trade names General Electric SF1188A and Toshu TSF 4452, respectively.

Emulsifiers used in the practice of this invention generally comprise 0 to 2 weight percent based on the total weight of the emulsion. However, one skilled in the art will recognize that the amount of emulsifier needed will vary according to types and amounts of polar and non-polar solvents used.

Ionic Surfactant

In one embodiment of the present invention, an additional surfactant is employed to assist in cleaning any hydrophilic stains. An ionic surfactant reduces surface tension and surrounds the particle or hydrophilic stain and solubilizes it in the emulsion. The ionic surfactant may also assist in emulsifying the mixture. Surfactants suitable for use in cleaning compositions are known to those of skill in the art. Generally the ionic surfactants suitable for use in the invention comprise molecules with a highly charged head group and a hydrophobic tail, wherein the molecule further comprises a hydrocarbon tail of 12 to 20 carbon atoms. Further suitable surfactants for use in an embodiment of the invention may comprise a hydrophilic-lipophilic-balance (HLB) value of between 2 and 10.

While cationic, anionic, zwitterionic and amphoteric surfactants may be employed in the practice of the invention, anionic surfactants are preferred. Examples of suitable surfactants include, alkali metal soaps such as the sodium, potassium, ammonium, and alkylammonium salts of higher fatty acids containing from about 8 to 24 carbon atoms and alkali metal and ammonium salts of organic sulfuric reaction products having in their molecular structure and alkyl group containing from about 10 to about 20 carbon atoms and a sulfonic acid or sulfuric acid ester group. More specific examples of suitable surfactants include, but are not limited to, sodium dodecylbenzene sulfate, fluorinated surfactants like the DuPont Zonyl™ surfactants (such as Zonyl™ FSP or Zonyl™ FSK), sodium lauryl sulfate, sodium lauryl sulfonate, sodium state, sodium lauryl sulfate, ammonium lauryl ether sulfonate, dialkyldiethyloxylateammonium salt, perfluoroalkylsulfobetaines, perfluoroalkylphosphate, siloxane benzyltrimethylammonium salts, quarternary alkyl ammonium siloxanes, carboxyalkyl siloxanes and polyether siloxane surfactants. In one embodiment of the present invention, the ionic surfactant is present in an amount up to 2 percent based on the total weight of the solution.

Additives

In one embodiment of the invention, the cleaning solution comprises a variety of additives which enhance the effectiveness of the solution. These include disinfectants, deodorizers and brighteners among other additives.

Odor is largely a matter of perception. Individual humans do not perceive odors in the same manner; thus, what can be objectable to one person is not so to another. Secondly, people become habituated to constant odors and do not detect them after extended periods of time. Odors can be removed, neutralized, or masked with another scent. The course of action is largely dependent on the odor to be removed. For the purposes of the invention odor can be thought of as an invisible stain which is perceived through its effect on olfactory sensors.

Odor molecules can be chemically reacted to become odorless. Bleach is capable of oxidizing many organic compounds. However, as most articles are organic compounds, bleach will harm the article in the process. Disinfectants remove odor-producing bacteria. Soaps with general anti-bacterial properties commonly contain quaternary ammonium salts as the disinfectants. The quaternary ammonium chlorides have been established as effective odor-control materials in and of themselves, particularly in combination with perfumes. They are readily found in household cleaners. Citrus oils and some synthetic aldehydes have excellent masking and odor-countering abilities.

In one embodiment of the invention, effective deodorizers include ammonium bromide salts and dihexyldecyldimethylammonium salts. It should also be noted that odor removal is increased in the presence of certain polar solvents such as water and alcohol. In one embodiment of the invention, deodorizers are present in an amount up to about 1 weight percent based on the weight of the solution.

In other embodiments of the invention, odors are the result of bacteria and other microbes within the article. Therefore, it is desirable to add a disinfectant to the cleaning solution. Acceptable disinfectants include chlorine bleach, dimethyldichlorohydrantoin, ethanol, heptanal, glutaric dialdehyde, and Phenonip™.

Fabric Softeners

In one embodiment of the invention, one of the benefits of using certain non-polar solvents such as cyclic siloxane is that the garments are left with nice “hand”, it feels nice, drapes well, and is largely free of wrinkles. It is believed that this is a result of residual solvent on the clothes. However, this benefit slowly goes away as the siloxane fluid evaporates. However, the addition of reactive siloxanes can impart a long-term benefit. The use of siloxane fluids improves the application (allowing easier application, through reaction, addition during the wash cycle, etc.) verses the use of aqueous article softeners where the softening material is added as an emulsion during the rinse. Acceptable fabric softeners include, for example, long chain reactive siloxanes, aldehydes and anhydrides.

Bleaches

In one embodiment of the invention it may be desirable to use bleach for enhanced stain removal and color brightening. Use of perborates, percarbonates, and sodium hypochlorite can be accomplished by dispersing the materials in the polar phase of the emulsified cleaning fluid. Bleaches such as isocyanric chloride or hydantoin chloride can also be used to improve solubility in the non-polar phase.

Optical Brighteners and Blueing Agents

In another embodiment of the invention optical brighteners and blueing agents may be added to correct for natural graying of articles with age and the redeposition of soils during the wash cycle. These materials can be either water-soluble or disperse in the non-polar medium.

Lint Scavengers and Depilatory Agents

In one embodiment of the invention, additives which have been developed to assist in the removal of hair fibers and extraneous fibers removed from the article during wash may be employed. Extraneous threads and hair are often electrostatically bound to article. In polar washing solvents, the charge can be dissipated by the conductive solvent or the solvent can support the charges on the fiber allowing the fiber to be carried out with the wash solution. In a non-polar fluid such as siloxanes, the hair and lint remains adhering to the more polar article. Reagents that can react with or coat the hair and lint fiber to make it more lipophilic can serve as additives in the siloxane wash to remove these undesired materials during cleaning. Aminosiloxanes are known to react with fiber surfaces to form non-durable siloxane coatings that could remove hair. Specially developed materials, such as 2-methylpyrimidinethinone siloxanes react rapidly and selectively with a proteinous surface to make the hair more appealing to the non-polar phase.

Inversion Inhibitors

In one embodiment of the invention, as ionic solvent levels increase, the ability of the emulsion to clean hydrophilic stains increases; however, increasing the polar solvent content also increases the chances for a gel to develop. This gel is an inverted emulsion, where the non-polar solvent is suspended in the polar solvent. The gel is not soluble in the primary emulsion and can break away from the article and clog lines, filters, screens, and other machine parts. This inverted emulsion is very heavy and can cause the drum motor to stall and can block filters, screens, and pumps essential to the proper operation of the washing machine. The gel is also so thick that it cannot be spun out or rinsed off the washed clothes with pure non-polar solvent. Addition of more polar solvent will wash the gel away, but as stated earlier, addition of more polar solvent can be harmful to the article being cleaned.

In one embodiment of the invention, it is possible to inhibit gel formation through the addition of excess surfactants, particularly the silicone and siloxane surfactants mentioned above. However, the addition of excess surfactants can leave an article feeling slimy or greasy after a wash. It is also possible to inhibit gel formation through the use of additional detergents.

In another embodiment of the invention, a method of reducing gel formation is through the addition of salt to the wash solution. It has been found that addition of a salt to the cleaning emulsion can prevent the formation of the inverted emulsion. Common salts work well in the invention such as sodium chloride, calcium chloride, zinc chloride and potassium chloride. However, any salt that acts as a vapor pressure depressant will be effective. Concentration of salt in the polar solvent of less than 0.2 moles per liter are preferred. In one embodiment of the invention, concentrations of salt in the polar solvent are about 0.005 to 0.05 weight percent based on the weight of the salt and solvent combined. In another embodiment of the invention, concentrations of salt in the polar solvent are about 0.015 weight percent based on the weight of the salt and solvent combined.

During an investigation of dual-phase emulsion wash solutions, it was discovered that good cleaning could be achieved using small percentages of water. The limit to the amount of water used is the amount of shrinkage observed for a particular type of fabric. Some fabrics shrink excessively with water, while others exhibit no noticeable shrinkage. The optimal amount of water to use is dependent on the fabric and the degree of necessary cleaning compared to shrinkage. One embodiment of the present invention solves this problem by separating fabrics in to groups depending on the type of fabric, the type of stain, and the materials affinity for water washing, then washing the grouped articles in a wash solution according to the characteristics of the articles and nature of the stains. Thus, separating the load by fabric type (or by care label) is the basis of “wash cycles”.

In one embodiment of the present invention, a method for washing articles is presented. First, the articles are separated by fabric type, and then washed in a wash process suitable for that fabric type to maximize stain removal, yet minimize damage associated with shrinkage. The basic wash process is a series of steps: loading clothes into a perforated basket, immersing the clothes with the desired amount of fluid, agitating the clothes by tumbling the basket, and spinning off as much as the wash liquor as possible. A rinse step may be inserted at this point, otherwise, the machine starts the drying sequence, and any residual cleaning fluid is evaporated with heated air. The spent fluid is then recovered, rectified and reused. By modifying the type and amount of cleaning fluid in the wash, accommodation can be made so that all types of fabrics can be cleaned in the machine. The amount of wash fluid used in an embodiment of the present invention will vary according to the wash cycle and amount of fabric to be cleaned. However, generally the ratio of articles to wash fluid will be 60 to 420 g/L. In a preferred embodiment the ratio of articles to wash fluid is 100 to 300 g/L, and in still other embodiments the ratio is 150 to 250 g/L. Furthermore, in another embodiment of the present invention this selection is made by means of electronic controls on the operator's panel in the form of operator-selected “wash cycles”, similar to the controls of conventional home laundering appliances.

In one aspect of the present invention, a wash cycle for “delicate” fabrics is provided. Delicate fabrics comprise those that are severely damaged by water such as rayon, wool, cashmere, silk, satin, velvet, chiffon and the like. Additionally, delicate fabrics optionally include those labeled “dry-clean only” or those that the user desires to clean only lightly.

Typically, dry-clean only garments are expensive garments made from more delicate fabrics and worn only lightly. That is to say, these clothes are unlikely to need heavy cleaning because they are used lightly and in relatively clean situations. It is enough to remove incidental body oils, odors, and particulate dirt, and relax any creases incurred by wearing. For these types of garments a wash procedure similar to a “traditional” dry-clean procedure will work best. Use of a non-polar wash fluid such as the preferred decamethylcyclopentasiloxane fluid will produce the best results.

In another embodiment of the present invention, the addition of small amounts of water or other polar solvent will aid in the cleaning. The apparent work done by the machine is increased by the addition of such agents. It is recognized that a large part of detergency is simple mechanical work and increasing mechanical work is excellent for particulate removal.

The added water or other polar solvent should be in the range of 0.125-1.5 percent based on the weight of the wash solution. Additional polar solvents suitable for use in an embodiment of the present invention include amines and lower alcohols, such as ethanol and methanol which are preferred over long chain alcohols that tend to act as surfactants. In a further embodiment of the present invention, amines are added in addition to water to enhance the cleaning ability of the polar phase.

All fabrics lightly soiled by body oils, hydrophobic matter (grease and oil), odors, trace amounts of water-based stains, and particulates can be cleaned in this cycle except fabrics with oil-soluble dyes. Fabrics with hydrophilic stains and/or those which can withstand larger amounts of water may be better suited for a different wash process.

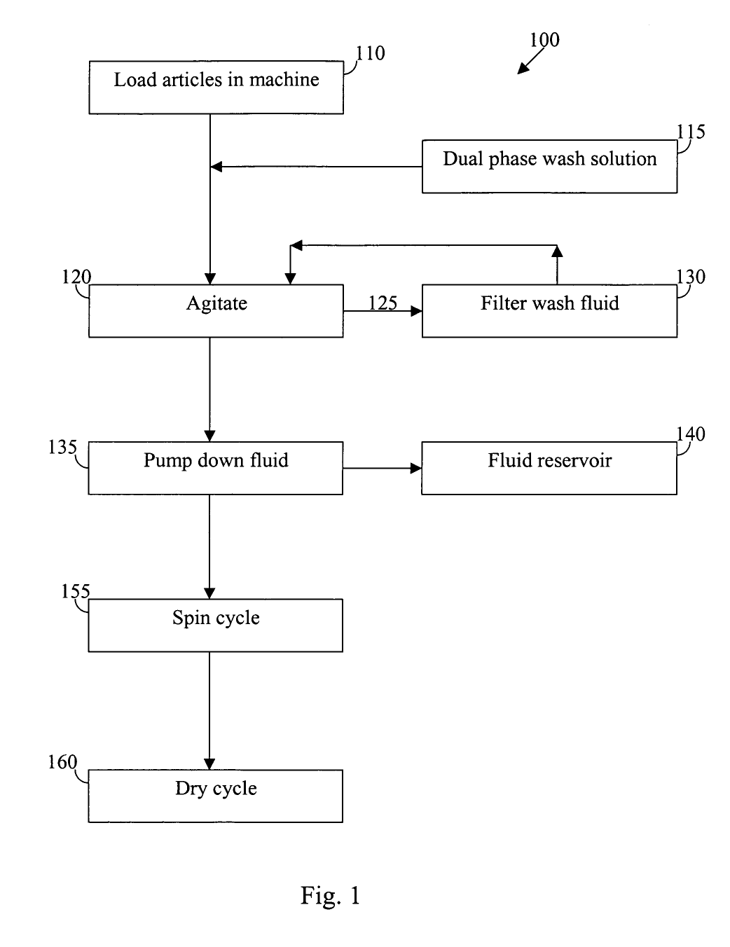

The preferred procedure for this cycle is shown in FIG. 1. First, stained articles are loaded into the basket in the washing machine 110 and immersed in 35-300 g of fabric/L of the dual phase wash solution 115. The optimum amount of fluid is dependent on the load size, but the preferred range is 100-250 g/L. The preferred method for preparing the wash solution comprises charging the desired water or other reagents into a detergent box and blending with decamethylcyclopentasiloxane by means of an in-line mixer or mixing valve.

The articles are agitated 120 for a period of time from 5 min to 40 min by tumbling. In a preferred embodiment of the present invention, the articles are tumbled at a speed less than 1 G so that saturated clothing drops from the basket at about the 10-11:00 position. Tumbling should be conducted so clothes are rolled in equal times in opposite directions to avoid knotting. The simplest agitation is a 1/1 rotation: 1 rotation in a clockwise or counterclockwise motion followed by 1 rotation in the opposite or reverse direction. The preferred action is 3/3 without a pause on the reverse, although cycles as high as 7/7 with a pause are possible.

In a further embodiment of the present invention, the wash liquor is recalculated 125 during the tumbling process to filter out lint and large particulates 130. Recalculating the fluid also provides the opportunity to spray wash, which increases the available work in the system.

The spin consists of a pump-down stage 135, where free, unabsorbed spent wash liquor is pumped out of the basket into a reservoir pending rectification 140. The basket is spun in one direction several times to balance to clothing load. Then a low-speed spin greater than 1 G is started, concurrent with further pumping, and then speed of the basket is increased stepwise until the maximum speed is achieved 155. In an embodiment of the present invention, maximum speeds for the spin cycle range from 100 to 400 G. In a preferred embodiment of the present invention the maximum spin comprises about 300 G. Clothes that are going to be subsequently dried 160 preferably require a spin of 4-10 min duration to reduce residual fluid to the lowest retained moisture content available via capillary and mechanical action. A heated drying stage 160 may occur concurrently with the spin stage or as a separate stage. Hot air, at a temperature of 60 to 180° F. is passed through the articles as they are rotated in the basket. This process continues until substantially all the wash fluid evaporates.

In another aspect of the present invention, a cleaning process is provided which utilizes a cleaning solution comprising a larger content of polar solvent. Accidents happen, and sometimes clothes require heavier cleaning than the aforementioned cleaning cycle can provide. This is commonly due to the presence of hydrophilic stains that are more effectively removed with a polar solvent. A cleaning composition comprising the wash fluid described above with an additional polar phase is the preferred wash solution for this embodiment. The additional polar phase is preferably water. The wash process is substantially the same as mentioned above, although for particularly well stained articles, this cleaning method and solution can be combined with a prespotter and/or pretreatment applied by hand on large stains to provide good cleaning.

The prespotting process is similar to traditional prespotting processes used currently. A small amount of a prespotting or pretreatment solution is applied directly to the stained or soiled area of the article to be cleaned. The solution is allowed to soak into the fabric and penetrate the stain for an amount of time determined by those skilled in the art. Once the pretreatment solution has had sufficient time to treat the stain, the article is washed according to the desired wash process described herein.

The additional polar solvent in the cleaning solution also functions to remove any detergent residue left by the prespotter. This residue can leave large damaging stains in and of itself, and is observed extensively when prespotters were used with less polar solvent in the wash solution, for example in the cycle described above.

Shrinkage also rises with increasing polar phase, but most fabrics are such that the shrinkage is below 3 percent, an amount determined to be where consumers start to notice shrinkage. Viscose rayon, a regenerated cellulosic fiber, is most sensitive to water, and is a poor candidate for this cycle. It should be realized that badly stained garments are at risk of uselessness regardless of treatment, and this cycle is still a gentle treatment.

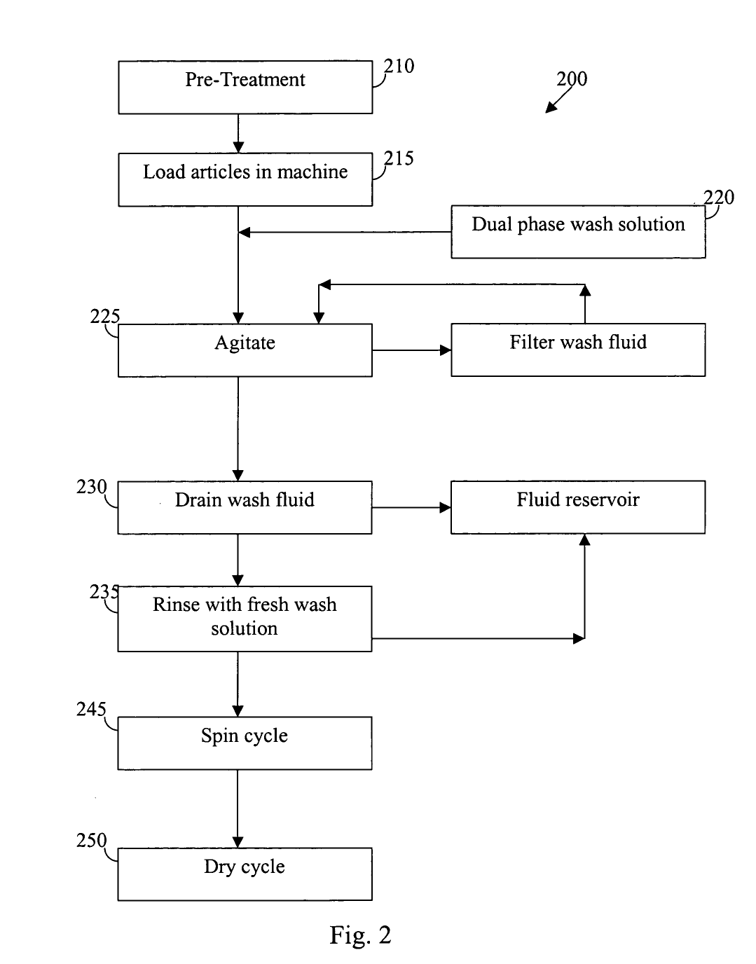

A representative procedure for this cycle, 200 shown in FIG. 2, comprises optionally treating large, deep or set stains by hand with a commercial prespotter following the manufacturer's instructions 210. Good results can be archived with a commercially available prespotter/pretreater such as Spray and Wash®, or Dryel® prespotter. Other siloxane cleaning compositions, such as those described in U.S. patent application Ser. No. 09/742,760 to Perry et al., incorporated by reference herein, are also suitable, but the choice is left to consumer preference. The treated articles are loaded in to the machine as described above and the dual phase wash solution comprising polar solvent in the range of 1-6.5 weight percent is added along with the non-polar solvent, preferably decamethylcyclopentasiloxane 220. The clothes are immersed and agitated 225 in this dual-phased fluid, drained 230 and optionally rinsed 235 with fresh wash liquor, spun 245 and dried 250 at 60-180° F. to remove residual solvent.

In another aspect of the present invention, a wash solution and process are provided for articles that can withstand larger amounts of water or other polar solvent without the wrinkling or shrinking associated with delicate garments. Garments and fabrics labeled as “machine washable” can withstand higher amounts of water without occurring adverse affects. Synthetic fibers, such as polyester, acrylic, nylon, Spandex®, Lycra®, and the like, have negligible rates of shrinkage and can be washed with impunity. Fabrics of natural origin are also suitable, particularly those garments labeled for machine care, as they are constructed with aqueous washing in mind. Materials previously washed with water are also acceptable, regardless of fabric and construction.

Fabrics and garments constructed of viscose rayon (except Tencel®), light wool garments prone to felting (because of heated drying), silks with cationic dyes that may be “pulled” by water and anionic surfactants, furs, and leathers would all be better suited for cycles 1 and 2 unless prior experience has indicated the process can be safely carried out.

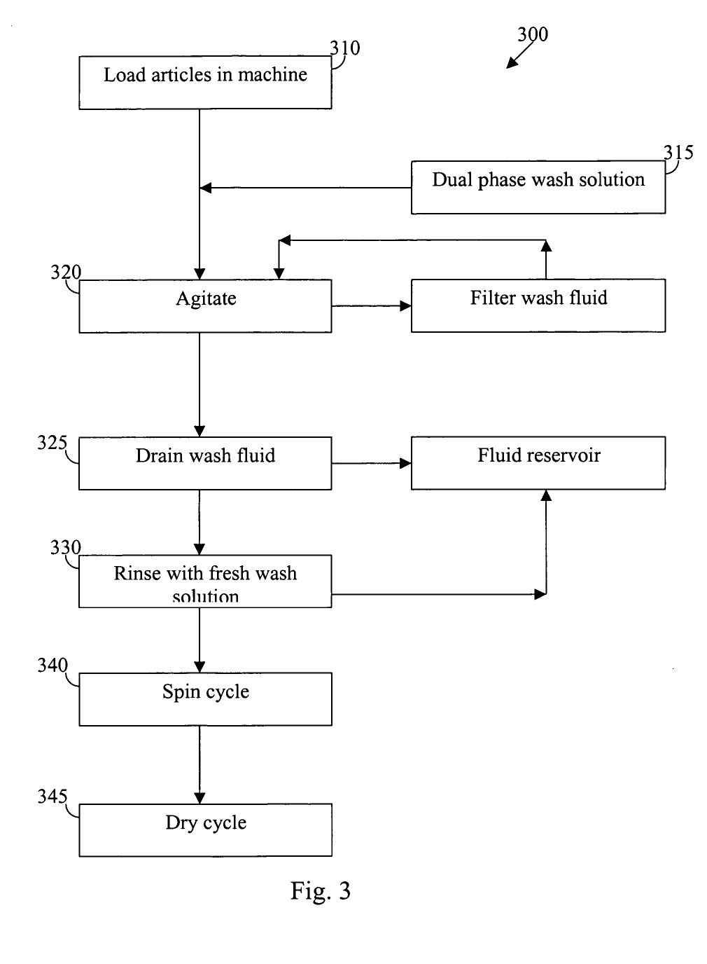

A representative procedure for this cycle, 300 shown in FIG. 3, comprises the following steps. First soiled articles are loaded into the machine 310. A dual phase cleaning solution is added 315 to immerse the clothes. The polar phase comprises 4-15 weight percent of the total fluid charge, and total fluid can range between 6-10 gals. Furthermore, a detergent composition, ranging from 0.01 to 0.5 weight percent of the fluid charge is added. In one embodiment of the present invention, preferred detergent compositions comprise an ionic surfactant, a non-ionic surfactant and an emulsifier. The clothes are then agitated 320, as described above. Following the wash step, a rinse 330 consisting of fresh wash liquor, without the detergent but optionally containing materials such as non-ionic or amphoteric surfactants or salts, is used to rinse the clothes. The fluid used in the rinse optionally comprises additional non-polar solvent and water in the same range as used in the preceding wash cycle. The clothes are immersed in the fresh fluid, agitated for a short time and the free rinse liquor is pumped off. The load is then spun 340 and dried 345 as described above.

Suitable detergent compositions comprise those enumerated above. Preferably, they comprise an ionic surfactant, optionally combined with a polyether/siloxane non-ionic surfactant, or silicone polyether copolymer sold as GE SF1488, and an emulsifier. A preferred emulsifier for this process is sorbitan sesquioleate. In another embodiment of the present invention, alkylamines, such as dodecylamine, or inorganic salts are employed to prevent undesirable gel formation. Further, any other desired additives, such as bleach, brighteners, are also added to the detergent concentrate. In a further embodiment of the present invention, heavy-duty commercially available home laundry detergents, such as Liquid Tide®, Fab®, or Wisk®, to give non-limiting examples, can be used in combination with the emulsifiers, and are already formulated with such laundry aids.

In one embodiment of the present invention, the detergent is introduced into the wash in the form of a concentrate. A detergent concentrate is prepared by emulsifying the polar solvents optionally with the surfactants into the non-polar solvent. This material is then charged to a detergent box on the machine. This concentrate is then diluted to proper strength during the wash by mixing with clean non-polar fluid, and if required, additional polar fluid. This mixing can be done in the detergent box or by an in-line valve. The polar fluid can be mixtures of polar solvents that are immiscible in the non-polar fluid.

In one embodiment of the invention, the concentrate comprises a polar solvent, emulsifier, surfactant and additives added to an amount of non-polar solvent in high concentrations to form a concentrated cleaning solution. In one embodiment of the invention, this concentrated cleaning solution may be mixed with excess non-polar solvent to dilute it before it is used. The relative amounts of these compounds will be significantly higher than in the non-concentrated embodiments described above. For example, the polar solvent may comprise up to 60 weight percent of the solution, the non-polar solvent may comprise up to 60 weight percent of the solution, the emulsifier may comprise up to 7 weight percent of the solution and the surfactant may comprise up to 10 weight percent of the solution. In other embodiments additives may be included in the concentrated solution as well. It should be noted that regardless of the concentrations of the components of the concentrated solution, after mixing with excess non-polar solvent the relative concentrations of the components will be within the ranges given elsewhere in this specification.

The dual-phase nature of the cleaning fluids of the present invention provide cleaning comparable to water washing alone, but with less wrinkling and shrinkage and leaving the garments with a desirable hand and drape. The ability to remove grease with the lipophilic fluid combines with the hydrophilic stain removal by the aqueous phase to yield a superior cleaning method and medium. Higher amounts of water can be used, even to the point of reversing the emulsion to its O/W form with similar cleaning abilities.

In a final aspect of the present invention, the method comprises selecting a wash cycle comprising only a polar solvent, preferably water. This is roughly equivalent to a conventional home laundry water wash. A representative procedure would be that soiled clothing is charged to the basket along with a desired detergent, and agitated for 5-40 minutes. The wash liquor is spun off, and a rinse of fresh water is conducted for 5-40 min. The rinse water is spun off, and the fabric is dried either in the machine, or transferred to another dryer. All machine-washable garments and textiles are suitable for this cycle.

The foregoing descriptions highlight many different methods for cleaning articles and several suitable wash solutions for use therein. The wash solutions for use in an embodiment of the present invention may be prepared in a number of ways. The non-polar solvent, preferably decamethylcyclopentasiloxane, will reside in a washing machine and can be cleaned and reused as described previously. The polar solvent, preferably water, and any detergents or additives will be added by the user of the method and machine.

In one embodiment of the invention, the polar solvent and additives are added directly to the wash tub with the articles to be cleaned. In another embodiment of the invention, the polar solvent and additives are added to a “detergent box” and mixed with the non-polar solvent prior to introducing the wash solution to the article. In a further embodiment of the present invention, the water and detergent are introduced into a line in the washing machine where the non-polar solvent flows. The combined constituents of the wash solution then flow into a static mixer before introduction to the wash tub.

While the above-mentioned methods and processes are those preferred in the present invention, it is understood that there are many different fabrics and stains requiring different washing methods. The methods disclosed in the present invention are not meant to be singular distinct methods, but rather examples of the different wash solution and process combinations that are used to clean various articles. The elements of any one process may be combined with one or more elements from another process to achieve the optimum level of cleanliness for a particular fabric and stain.

Furthermore, the present invention has been described with reference to a washing machine primarily designed for home use. However, it should be noted that the same compositions and methods can be applied to a commercial sized laundry or coin-op machines. Though the total fluid amounts will vary depending on the size of machine used, the basic process and fluid to article ratio will remain substantially the same.

1-20. (canceled)

21. A method for cleaning an article comprising:
charging an article to a washing machine comprising a washing drum;
exposing the article in the wash drum to a dual phase wash solution comprising 0.125 to 20 weight percent of a polar solvent and a non-polar solvent, wherein the polar solvent is emulsified in the non-polar solvent and wherein the wash solution further comprises 0.125 to 20 percent water, a detergent comprising up to 0.5 weight percent of an ionic surfactant, up to 0.5 weight percent of a non-ionic surfactant and up to 0.5 weight percent of an emulsifier;
agitating the article and wash solution in the washing drum; and
separating the wash solution from the article by allowing the wash solution to drain out of the drum and spinning the drum to drive off residual wash fluid through centrifugal force.

22. The method of claim 21, wherein the polar solvent comprises water and the non-polar solvent comprises decamethylcyclopentasiloxane.

23. The method of claim 21 wherein the wash solution comprises a siloxane based non-polar solvent and 0.125 to 20 percent polar solvent.

24. The method of claim 22 wherein the wash solution comprises 0.125 to 2 percent polar solvent.

25. The method of claim 22 wherein the wash solution comprises 1 to 6.5 percent polar solvent.

26. The method of claim 22, wherein the wash solution comprises 4 to 15 percent polar solvent.

27. The method of claim 21, wherein the detergent composition is present in a range from 0.01 to 0.5 percent of the total wash solution.

28. The method of claim 21, wherein the detergent comprises a commercially available home laundry detergent.

29. The method of claim 21, wherein the article to wash solution ratio is 60-420 g/L.

30. The method of claim 21, wherein the article to wash solution ratio is 100-300 g/L.

31. The method of claim 21, wherein the article to wash solution ratio is 150-250 g/L.

32. The method of claim 21, wherein before the article is charged to the washing machine, the article is pretreated by applying a cleaning solution directly to the stained or soiled portion of the article and allowing the cleaning solution to penetrate the stain.

33. The method of claim 21, further comprising a rinse step wherein the article is mixed with a second wash solution after the first wash solution has been separated from the article; agitating the article and the second wash solution; and draining and separating the second wash solution from the article.

34. The method of claim 21, wherein the constituents of the wash solution are introduced into a static mixer before the article is exposed to the wash solution.

35. A dual phase wash solution comprising 0.125 to 20 weight percent of a polar solvent and a non-polar solvent, wherein the polar solvent is emulsified in the non-polar solvent and wherein the wash solution further comprises 0.125 to 20 percent water, a detergent comprising up to 0.5 weight percent of an ionic surfactant, up to 0.5 weight percent of a non-ionic surfactant and up to 0.5 weight percent of an emulsifier.

36. The wash solution of claim 35 further comprising a siloxane based non-polar solvent and 0.125 to 20 percent polar solvent.

37. The wash solution of claim 35 wherein the wash solution comprises 0.125 to 2 percent polar solvent.

38. The wash solution of claim 35 wherein the wash solution comprises 1 to 6.5 percent polar solvent.

39. The wash solution of claim 35 wherein the wash solution comprises 4 to 15 percent polar solvent.

40. The wash solution of claim 35, wherein the detergent comprises a commercially available home laundry detergent.
